(19) United States
(12) Patent Application Publication
(10) Pub. No.: US 2025/0327666 A1
(43) Pub. Date: Oct. 23, 2025

(54) Method and Assistance System for Predicting a Driving Path, and Motor Vehicle

(71) Applicant: Bayerische Motoren Werke Aktiengesellschaft, Muenchen (DE)

(72) Inventors: Jens KLAPPSTEIN, Muenchen (DE); Daniel OBERMAIER, Wolnzach (DE); Luca TRENTINAGLIA, Eichenau (DE)

(21) Appl. No.: 18/870,888

(22) PCT Filed: Jun. 2, 2023
(86) PCT No.: PCT/EP2023/064778

§ 371 Date: Dec. 2, 2024

(30) Foreign Application Priority Data
Jun. 9, 2022 (DE) 10 2022 114 589.1

(51) Int. Cl. G01C 21/00

(52) U.S. Cl. CPC G01C 21/005; G01C 21/3863

(57) ABSTRACT

A method and an assistance system predicts a driving path of a motor vehicle. According to the method, a respective surroundings scenario lying ahead of the motor vehicle in the driving direction is ascertained. The trustworthiness of a plurality of different data sources and/or of the data which originates therefrom and on the basis of which the driving path can be predicted are ascertained for the surroundings scenario. A plurality of the data originating from the different data sources is then fused together in a weighted manner according to the ascertained trustworthiness and is used to predict the driving path of the motor vehicle.

### BACKGROUND AND SUMMARY

The present invention relates to a method and to an assistance system for predicting a driving path of a motor vehicle, and also to an appropriately equipped motor vehicle.

An estimate—that is to say, a prediction—for a prospective motion—to be more exact, for a prospective path of motion or region of motion—of the motor vehicle can be useful for various assistance functions of a motor vehicle, as well as for automated vehicle guidance. Such a prediction or estimate can be made, for instance, on the basis of running-dynamics data pertaining to the motor vehicle. However, in various situations this may lead to errors which, in turn, may lead to further errors of functions or systems based thereon. For improved functionality, performance and security of corresponding assistance functions and automations, improvements over conventional approaches are accordingly desirable.

For instance, EP 1 844 373 B1 describes a method for course prediction in driver-assistance systems for motor vehicles, in which a dynamic course hypothesis is established by reference to running-dynamics data pertaining to the vehicle. In this method, an infrastructure course hypothesis is firstly established by reference to data from a source of information describing a traffic infrastructure. By reference to features of the source of information, a weighting factor is calculated that describes the reliability of the infrastructure course hypothesis. Furthermore, an amalgamation of the infrastructure course hypothesis with the dynamic course hypothesis is provided, with weighting in accordance with the calculated weighting factor for the purpose of creating a definitive course hypothesis.

A possible use of a predicted driving path is described in DE 10 2018 127 270 A1. In this patent, a control unit is provided for a vehicle which includes a control unit that enables a driver of the vehicle to effect a control input for the longitudinal and/or lateral guidance of the vehicle. This control unit has been set up to ascertain a permissible driving path for the vehicle, starting from a current state of the vehicle. The driving path exhibits a large number of dimensions, and indicates for each dimension a permissible range that can be implemented by the vehicle technically and/or without accident. The large number of dimensions include a spatial dimension and a running-dynamics dimension. Furthermore, the control unit has been set up to implement the control inputs of the driver in such a manner that the vehicle remains within the driving path in the course of a journey. Hence an automated longitudinal and/or lateral guidance, capable of being controlled by a driver, of a vehicle can be made possible in efficient manner, in particular in order to enhance the comfort and the driving enjoyment for the driver.

The object of the present invention is to enable a particularly accurate and robust prediction of a driving path of a motor vehicle.

In accordance with the invention, this object is achieved by virtue of the subjects of the independent claims. Possible configurations and developments of the present invention are disclosed in the dependent claims, in the description and in the figures.

The method according to the invention can be applied when predicting a driving path of a motor vehicle. Such a driving path or driving corridor extends away from the motor vehicle in the direction of travel thereof and specifies a region that the motor vehicle will foreseeably drive through or along subsequent to the current instant in the given case. In one step of the method according to the invention, an environmental scenario currently situated ahead of the motor vehicle in the direction of travel in the given case is ascertained. In general, a kind or type of environmental scenario or a concrete or unique environmental scenario which obtains only precisely at the respective point can be ascertained. For the purpose of ascertaining the respective environmental scenario, the current position of the motor vehicle, for instance, can be ascertained and taken into account, possibly relative to a predetermined—in particular, fixed—coordinate system and/or relative to a certain feature in the respective environment that defines or co-determines the respective environmental scenario, such as a roundabout, a junction or such like.

An environmental scenario in the present sense may be, for instance, an intersection, an imminent turn-off, a roundabout, a play street, a junction or such like. An environmental scenario here may accordingly be a spatially limited region defined by its type and/or properties, which can be driven along or through by the motor vehicle. Similarly, a corresponding maneuver of the motor vehicle—such as driving toward a certain feature, driving through a certain region, leaving a certain region or feature and/or such like—may define the respective environmental scenario. For instance, approaching a roundabout, entering the roundabout, driving within the roundabout and/or exiting the roundabout may be differing environmental scenarios.

An environmental scenario may also have been influenced or defined, or distinguished from other environmental scenarios, by the current environmental conditions, such as the weather conditions, the lighting conditions, the local traffic density, the condition of the roadway—for instance, dry, wet or snow-covered—and/or such like. Accordingly, a certain roundabout in the dark and with a snow-covered roadway and/or with relatively high traffic density, for instance, may present a different environmental scenario than the same roundabout in daylight, with a dry roadway and/or minimal traffic density, in particular with an absence of vehicles except for the motor vehicle.

In a further step of the method according to the invention, the degrees of trustworthiness of several different, in particular differing, data sources and/or data items originating therefrom—that is to say, from different data sources—are ascertained for the respective ascertained environmental scenario or, to be more exact, as a function of, or in accordance with, the respective ascertained environmental scenario. It is a question of data sources or data, on the basis of which—that is to say, from which—the driving path can be predicted. Various data sources or data may accordingly exhibit differing or variable absolute and/or relative degrees of trustworthiness in differing environmental scenarios. The degrees of trustworthiness may specify or describe a respective reliability, dependability, practical usefulness or such like, such as obtains or is to be expected in the respective environmental scenario. For instance, lidar data in the event of snowfall or rain may be less trustworthy than lidar data in another, precipitation-free environmental scenario, or than camera data or map data in the same environmental scenario. Similarly, in the case of relatively pronounced curviness, or relatively strong curvature, of a road contour situated ahead, camera data, for instance, may be less trustworthy than map data or trajectory data that describe trajectories of road-users traveling ahead, or such like. Similarly, the trustworthiness of radar data pertaining to a roadway boundary may depend, for instance, on the type of roadway boundary. For instance, radar data that characterize a location or even a contour of a roadway boundary may exhibit a greater degree of trustworthiness in a first environmental scenario in which the roadway boundary is constituted by a curb or a protective barrier than in a second environmental scenario in which the roadway boundary is constituted by a sward or merely by a roadway marking.

In a further step of the method according to the invention, several—that is to say, a selection or all—of the data items originating from the various data sources are amalgamated with one another, weighted in accordance with the ascertained degrees of trustworthiness. By this means—that is to say, for instance, by the amalgamating of the data in an appropriate predetermined amalgamation-and-prediction model, or by using the amalgamated data as input for a predetermined prediction model—the driving path is predicted or updated. The data being used here may be selective data, or individual data, or data streams.

The amalgamation of the data may already enable an improved—for instance, more accurate or more reliable—prediction—that is to say, estimate—of the driving path, for instance in comparison with the prediction of the driving path on the basis of individual data or data sources. In addition, however, a scenario-driven approach is proposed here. The detection of the respective environmental scenario may typically be more easily, more accurately and more reliably possible than the prediction of the driving path itself. The assignment or selection of trustworthy data and data sources—that is to say, the assessment of the degrees of trustworthiness of the various data and/or data sources for various environmental scenarios—can take into account overall findings acquired independently of the situation, which, for instance, cannot be detected “live”—that is to say, by reference to current sensor data or measurement data—for the respective motor vehicle itself. Consequently the weighting, dependent on the respective environmental scenario, of the data—and therefore accordingly the consideration of differing properties and facts of differing environmental scenarios—enables a more robust, more accurate and more reliable prediction of the driving path, for instance in comparison with conventional approaches based, for instance, solely on the data available in the given case without more extensive information.

In one possible configuration of the present invention, the data and/or data sources comprise differing data and/or data sources, for instance depending upon the respective or local availability—that is to say, for instance, depending on the equipment provided in the motor vehicle, on extraneous vehicles or road-users in the respective environment of the motor vehicle, or in the respective environmental scenario, on a respective local traffic infrastructure, on the presence or even the completeness of corresponding data and/or such like. These data or data sources may be predetermined map data. It may be a question of a respective SD map or HD map. Such map data may, for instance, contain—that is to say, specify—curvatures for waypoints situated ahead of the motor vehicle in the direction of travel. By reference to such waypoints and/or curvatures, a possible contour, situated ahead, of a respective road can be determined. This contour can, in turn, be used as a basis for the prediction of the driving path—that is to say, it may enter into the prediction of the driving path.

Similarly, the data and/or data sources may include a road model, for estimating a contour, situated ahead, of the road which is then or foreseeably driven along by the motor vehicle in the given case, and/or an output of such a road model—that is to say, a road contour estimated by such a predetermined road model, or such like. Such a road model may represent the road contour situated ahead, for instance on the basis of respective camera data, the map data, current navigation data in the given case, for instance from a navigation system of the motor vehicle, and/or such like.

Similarly, the data and/or data sources may be, or may include, a detection of a roadway edge or a detection of a peripheral housing development. Such a detection of a roadway edge may, for instance, specify or characterize a roadway edge or a roadway housing development with regard to a location, a contour, a type and/or such like. Such a detection of a peripheral housing development or detection of a roadway edge may be provided by various sensors or by an amalgamation of various sensor data or measurement data, such as, for instance, camera data, lidar data, radar data and/or such like. A roadway edge or a peripheral housing development in the present sense may, for instance, be represented by a protective barrier, a curb, a sward, pylons and/or such like.

Similarly, the data and/or data sources may be, or may include, cluster data that specify earlier vehicle movements in the respective region. Such cluster data may, for instance, have been specified or summarized in a so-called learned map, containing learned map data, in which trajectories of cluster vehicles in the course of driving through the respective region at earlier instants have been specified or processed. Such cluster data can, for instance, be retrieved from an appropriate server device external to the vehicle, such as a computing center, a cloud server, a back-end or such like.

Similarly, the data and/or data sources may be, or may include, “live” trajectories of other road-users moving within the respective environmental scenario at the respective instant—that is to say, for instance, simultaneously with the motor vehicle or immediately preceding it. Such “live” trajectories can, for instance, be captured by means of environmental sensorics of the motor vehicle, and/or can be obtained via Car2Car communication sent from the other road-users.

Similarly, the data and/or data sources may be, or may include, at least one maneuver hypothesis of an assistance system of the motor vehicle. Such an assistance system can accordingly, for instance, establish a prediction for the motion or a maneuver of the motor vehicle. This can be undertaken, for instance, on the basis of the road model, on the basis of map data, on the basis of navigation data, on the basis of a current running condition or operating state of the motor vehicle, and/or such like. Such maneuver hypotheses may, for instance, specify or predict whether the motor vehicle will continue driving in a lane currently being driven along in the given case or will carry out a change of lane or a turning maneuver or such like. This may directly specify or influence the driving path, and may consequently be incorporated particularly profitably into the prediction of the driving path.

Similarly, the data and/or data sources may be, or may include, steering data pertaining to the motor vehicle. These data may, for instance, include or specify a current or immediately preceding steering angle, a current or immediately preceding rate of change of the steering angle and/or such like. Such steering data may directly specify or influence the direction of travel or direction of motion of the motor vehicle and may therefore be incorporated particularly profitably into the prediction of the driving path.

Similarly, the data and/or data sources may be, or may include, a current or immediately preceding yaw-rate of the motor vehicle. In other words, the data and/or data sources may accordingly be, or may include, operating-state data or running-dynamics data pertaining to the motor vehicle. For instance, from the steering data or from a steering movement or steering-wheel actuation by a driver of the motor vehicle and from the yaw-rate of the motor vehicle a signal can be processed that can specify, represent or predict a path or route, situated immediately ahead, of the motor vehicle in the vicinity immediately adjoining the current position of the motor vehicle in the given case. Such a signal may therefore be incorporated particularly profitably into the prediction of the driving path. The vicinity in the present sense may extend from the motor vehicle in the direction of travel as far as a distance of, for instance, 10 m or 20 m or 30 m or such like.

Similarly, the data and/or data sources may be, or may include, a respectively current driving-path prediction of a device for machine learning. Such a device may accordingly be, or may include, for instance, an artificial neural network trained to predict the driving path. It may be a question, in particular, of a device pertaining to the motor vehicle. The driving-path prediction based on machine learning can be made, for instance, by appropriate evaluation or by a processing of sensor-based object detections. In other words, the corresponding device can accordingly generate a dedicated contour of a possible path of the motor vehicle. This driving-path prediction may be based upon data and/or data sources other than those mentioned here, or only upon some of them, but may process them in accordance with a different principle. Such a driving-path prediction may therefore be a useful factor in the ultimate optimal prediction of the driving path.

The data and/or data sources proposed herein as input for the prediction of the driving path may present differing advantages and disadvantages in differing environmental scenarios, and consequently can enable overall a particularly robust, accurate and reliable prediction of the driving path in each instance in a large number of differing environmental scenarios.

In a further possible configuration of the present invention, the degrees of trustworthiness are inferred, at least partially, from a predetermined map in which a location-specific degree of trustworthiness has been specified for at least one data source and/or data type. In such a map, for at least one specific location or spatial region a degree of trustworthiness for at least one data source or one data type in this region or at this location—that is to say, in the case of a deployment there of, for instance, a sensor for detecting objects or a road contour or such like—has accordingly been specified. Therefore the degrees of trustworthiness can be ascertained particularly easily and quickly. This can assist a real-time application of the method according to the invention. The map being used here may particularly easily contain particularly robust and reliable particulars of the reliability data, since it can be generated separately and is consequently, for instance, not restricted by respective limitations of environmental sensorics of the motor vehicle in the respective situation or by the environmental conditions then obtaining in the given case. In addition, a large number of differing items of information that, in addition, can be acquired in differing situations under differing conditions and at differing times may enter into such a map. Through the use of the map as proposed herein, location-individual special features can be taken into account particularly easily. This may be useful, since traffic-management features or infrastructure features of the same type, for instance roundabouts, may, for instance, also exhibit individual properties and special features that cannot be taken into account, or that can only be taken into account with less precision and less detail, by generally applicable, permanently predetermined rules or specifications for reliability in the region of such features.

In a further possible configuration of the present invention, environmental data that characterize the respective environmental scenario are recorded by means of environmental sensorics of the motor vehicle during the operation of the motor vehicle. Such environmental data can be recorded, for instance, when the respective environmental scenario is being approached and/or within the respective environmental scenario—that is to say, when it is being driven through. On the basis of these environmental data, the degrees of trustworthiness are then ascertained dynamically in each instance, at least partially “live” or in real time-that is to say, during the operation of the motor vehicle. In other words, these degrees of trustworthiness are then accordingly ascertained anew in the course of each approach to the respective environmental scenario or each time the respective environmental scenario is driven through. Therefore these degrees of trustworthiness can then take into account respective individual actual facts, as well as properties of the motor vehicle then obtaining in the given case, and also corresponding changes. For instance, dynamic influences or influences changing in the course of time—such as weather conditions, changes in vegetation, contaminations, wear or creeping alignment errors or such like—on the environmental sensorics of the respective motor vehicle can be taken into account automatically. Therefore a prediction of the driving path that is better adapted to the respective actual situation in comparison with permanently predetermined—that is to say, static—degrees of trustworthiness can be made possible under certain circumstances. For the purpose of ascertaining the degrees of trustworthiness, predetermined parameters of the environmental data, or of various individual sensors being used for recording the environmental data, can, for instance, be ascertained and taken into account, such as an achievable sharpness, a respective variance or scatter of measured values or data points, a signal jitter, an error-rate, an occurrence or even a frequency or strength of artefacts, a signal-to-noise ratio and/or such like.

In a further possible configuration of the present invention, a distance, as far as which, starting from the current position of the motor vehicle in the given case, at least one of the data sources and/or at least some of the data is/are to be used for predicting the driving path, is also ascertained as a function of the environmental scenario ascertained in the given case. This data source or these data is/are then used, for instance, only for predicting the driving path as far as the respective determined spacing. Individual spacings can be ascertained for various data sources and/or for various data. A contour of the driving path going beyond the spacing can then be undertaken on the basis of other, or the remaining, data sources and/or data. The configuration of the present invention proposed herein can enable a particularly reliable and accurate prediction of the driving path. This may be the case, for instance, when differing sensors that serve as data sources or that supply the data have differing effective ranges. For instance, first sensor data and second sensor data supplied by a first sensor and by a second sensor can be amalgamated for the prediction of the driving path as far as a certain distance from the motor vehicle. For the prediction of the driving path in a region behind or beyond this distance, the first sensor data supplied by the first sensor, for instance, can then be disregarded.

In a further possible configuration of the present invention, only those data sources and/or data, the degree of trustworthiness of which, ascertained for this purpose, corresponds to at least a predetermined minimum degree of trustworthiness—that is to say, is at least as great as a predetermined threshold value—are incorporated into the amalgamation and into the prediction of the driving path. In other words, data sources and/or data, the degree of trustworthiness of which is less than the predetermined minimum degree of trustworthiness—that is to say, lies below the predetermined threshold value—can accordingly be discarded, where appropriate in certain regions. As a result, an unpredictable and, where appropriate, unjustified distortion of the prediction of the driving path due to particularly untrustworthy data sources and/or data can be avoided or reduced. The configuration of the present invention proposed herein can be applied at least when, in each instance, at least a predetermined number or quantity of data sources and/or data items, the degree of trustworthiness of which corresponds to at least the predetermined minimum degree of trustworthiness, remain. Otherwise, one, several or all of the data sources and/or data items, the degree of trustworthiness of which is less than the predetermined minimum degree of trustworthiness, may accordingly also enter into—that is to say, may be incorporated into—the amalgamation or, to be more exact, into the prediction of the driving path. As a result, a data-based prediction of the driving path can be ensured, even under unfavorable conditions or in marginal cases.

In a further possible configuration of the present invention, for at least some of the data the uncertainty or quality factor thereof is ascertained in addition. These data are then also weighted in accordance with these uncertainties, or quality factors, so that a greater uncertainty—that is to say, a lower quality factor—results in a lower weighting. The degrees of trustworthiness may accordingly be based upon fundamental facts, such as geometrical restrictions or structural facts. In contrast, the uncertainties additionally taken into account here may be individual properties of the data actually recorded or measured in each concrete case, such as a respective sharpness, a respective signal-to-noise ratio, a respective error-rate or artefact-rate and/or such like. The uncertainties may accordingly—where appropriate, unlike the degrees of trustworthiness—be different, also in the case of several confrontations with the same environmental scenario; for instance, they may fluctuate randomly. The uncertainties may accordingly be measurement uncertainties which arise individually in the given case. By virtue of the configuration of the present invention proposed herein, ultimately a particularly robust, accurate and reliable as well as situation-adapted or situation-individualized prediction of the driving path can be made possible.

In a further possible configuration of the present invention, objects in the respective environment of the motor vehicle that are relevant for the guidance of the motor vehicle are determined or selected on the basis of the driving path predicted in the given case. On the basis of the driving path, it can accordingly be ascertained here, for instance, which objects detected in the respective environment of the motor vehicle—such as, for instance, other road-users—are more relevant for an assisted or automated longitudinal control, or spacing control, of the motor vehicle, and/or such like. For this purpose, an object may, for instance, be classified as relevant if it is located within the predicted driving path, at least if it is located at most at a predetermined spacing from the motor vehicle, is not moving away from the motor vehicle, and/or such like. Such a selection of relevant objects can enable a particularly robust, reliable and safe, as well as particularly comfortable, control of the vehicle.

A further aspect of the present invention is an assistance system for a motor vehicle. The assistance system according to the invention exhibits an interface for capturing various data that can be used for predicting a driving path of the motor vehicle, a processor device—such as a microchip, microprocessor or microcontroller or such like—and a computer-readable data memory coupled therewith. The assistance system according to the invention has been set up to execute the method according to the invention, in particular automatically. For this purpose, an operating program or computer program may have been stored in the data memory, which codes or implements the method steps, measures or sequences or corresponding control instructions described in connection with the method according to the invention. This operating program or computer program may then be capable of being executed by means of the processor device, in order to execute the corresponding method or to bring about the execution thereof. The assistance system according to the invention may have been configured, for instance, as a control unit or computer module or such like. The assistance system according to the invention may also include the environmental sensorics, a communication device, a device or a module for generating or outputting control signals and/or such like. The assistance system may have been set up to store the driving path, predicted in the given case, in the data memory, and/or to output it or make it available via the interface or via a further interface.

A further aspect of the present invention is a motor vehicle which exhibits environmental sensorics, for recording or capturing environmental data that characterize an environmental scenario situated ahead and that, in particular, can be used for predicting a driving path, and an assistance system according to the invention. The assistance system may, for instance, have been coupled with the environmental sensorics via an on-board network of the motor vehicle. The motor vehicle according to the invention may, in particular, be the motor vehicle mentioned in connection with the method according to the invention and/or in connection with the assistance system according to the invention, or may correspond to this motor vehicle.

Further features of the invention may emerge from the claims, the figures and the description of the figures. The features and combinations of features mentioned above in the description, and also the features and combinations of features shown below in the description of the figures and/or in the figures alone, are capable of being used not only in the respectively specified combination but also in other combinations or on their own without departing from the scope of the invention.

### BRIEF DESCRIPTION OF THE DRAWINGS

FIG. 1 is a partial schematic general representation of a first traffic scenario for illustrating a method for estimating a driving path; and

FIG. 2 is a partial schematic general representation of a second traffic scenario for illustrating the method.

In the Figures, identical and functionally identical elements have been provided with the same reference symbols.

### DETAILED DESCRIPTION OF THE DRAWINGS

In road traffic, a prediction of a driving path can offer a useful basis for a variety of different assistance functions or automations. For a reaction appropriate to a situation, a prediction of the driving path is desirable that is as robust, accurate and reliable as possible. One approach for this purpose consists in the use and amalgamation of differing data. However, it has been shown that not all the available data sources or data types contribute with equal usefulness and accuracy to the prediction of the driving path in every situation, or in every traffic scenario or environmental scenario. In other words, in differing environmental scenarios differing data sources and data types may accordingly exhibit differing degrees of trustworthiness for a prediction of the respective driving path.

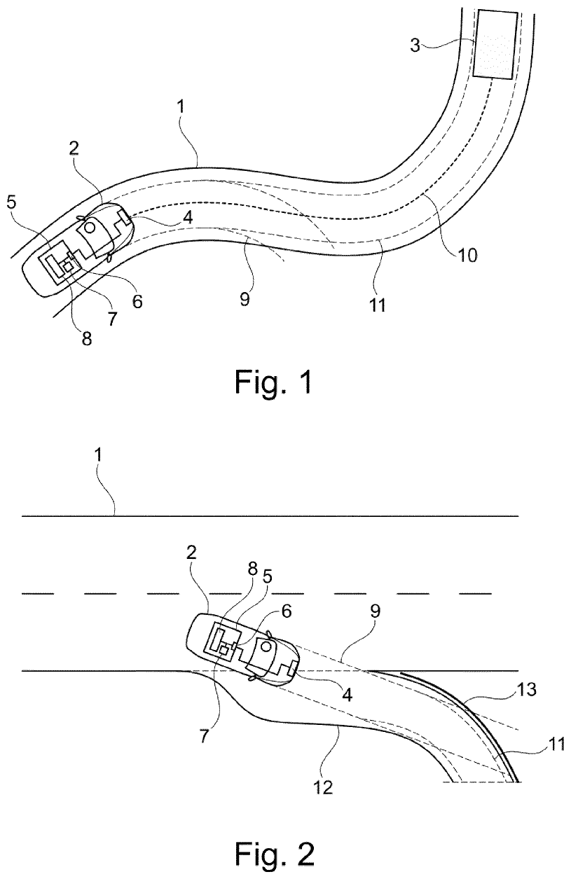

For the purpose of illustration, FIG. 1 shows an exemplary partial general representation of a first traffic scenario or environmental scenario. Here, a section is represented of a curve of a road 1 on which a motor vehicle 2 is moving. An extraneous vehicle 3 is traveling ahead of the motor vehicle 2. The motor vehicle 2 exhibits environmental sensorics 4 for recording environmental data characterizing the respective environment and therefore also the respective environmental scenario. Furthermore, the motor vehicle 2 is equipped with an assistance system 5 for predicting or estimating a driving path, situated ahead, of the motor vehicle 2. The assistance system 5 here comprises, in exemplary manner, an interface 6, a processor 7 and a data memory 8. Data recorded by means of the environmental sensorics 4 can, for instance, be captured via the interface 6. These data may be data from various individual sensors of the environmental sensorics 4, which may, in particular, be of differing types. Similarly, via the interface 6 further data can be captured, for instance a position and an operating state of the motor vehicle 2, motion data or trajectory data pertaining to the extraneous vehicle 3, which can be received, for instance, via a Car2Car data connection, cluster data and/or map data retrieved from a server device external to the vehicle, and/or the like.

In principle, a prediction of the driving path may be based upon individual items of these captured data. However, a prediction of the driving path on the basis of the current steering angle of the motor vehicle 2, for instance, might lead to an incorrect estimate 9 of the driving path, indicated here schematically.

Therefore an environmental scenario currently obtaining is firstly ascertained, for instance on the basis of at least some of the captured data. The captured data are then amalgamated with one another in order to obtain an improved prediction or estimate of the driving path. This is undertaken as a function of the environmental scenario ascertained in the given case. Accordingly, it is taken into account that various data in the respective environmental scenario may exhibit differing degrees of trustworthiness. For instance, by reason of the curviness of the road 1, camera data may image the contour of the road 1 only to a limited extent. In comparison with this, a contour 10 of the road 1 can be inferred with greater trustworthiness from map data, for instance, or can be estimated by reference to trajectory data pertaining to the extraneous vehicle 3 traveling ahead, or such like. The various captured data items are therefore weighted at the time of their amalgamation in accordance with their degrees of trustworthiness. The degrees of trustworthiness can be retrieved, for instance, from a predetermined database, possibly stored in the data memory 8, in which the degrees of trustworthiness of various data or data sources have been specified for various environmental scenarios. Similarly, the degrees of trustworthiness can be determined dynamically, at least partially, for instance as a function of the properties of the specific data captured in each concrete case. This then results in a correspondingly improved driving-path estimate 11.

The—absolute and/or relative—degrees of trustworthiness, as well as the availability of various data or corresponding data sources, may, however, be different in other environmental scenarios. In this respect, FIG. 2 shows, in exemplary manner, a partial schematic general representation of a further environmental situation. Here, another section of the road 1 is represented. In the environmental scenario represented here, the motor vehicle 2 is leaving the road 1 at an exit 12. Here too, a prediction or estimate of the driving path based solely upon the steering angle might, for instance, lead to an incorrect estimate 9. Similarly, corresponding predictions or estimates that are based, for instance, upon camera data that are limited in their effective range or, where appropriate, upon incomplete, outdated or inaccurate map data or such like may lead to such an incorrect estimate 9. By way of example, however, a roadway edge 13, for instance a protective barrier, can be captured here with greater trustworthiness by a front-radar device of the motor vehicle 2, for instance by reason of the given arrangement or geometry and the generally reliable detectability of protective barriers within the capture zone of a front radar. Accordingly, the steering angle, for instance, may be less trustworthy here and therefore cannot be used or can be used only for a part of the driving-path estimate 11 in the vicinity of the motor vehicle 2 and may be weighted less heavily than comparatively more trustworthy radar data from the front-radar device, which may be weighted correspondingly more highly and, in addition, may also be used for a part of the driving-path estimate 11 further away from the motor vehicle 2 in the direction of travel.

Similarly, there may be a large number of further basic types of environmental scenario and also a large number of individual—that is to say, location—specific-environmental scenarios. For these scenarios, respective individual degrees of trustworthiness can be ascertained for the differing data sources and/or data or data types—that is to say, they can, for instance, be retrieved from a corresponding specification or can be determined dynamically and used for the respective prediction or estimate of the driving path.

Overall, the examples described show how a scenario-driven use of multimodal sensor data for estimating the driving path of a vehicle can be realized.

### LIST OF REFERENCE SYMBOLS

1 road
2 motor vehicle
3 extraneous vehicle
4 environmental sensorics
5 assistance system
6 interface
7 processor
8 data memory
9 incorrect estimate
10 road contour
11 driving-path estimate
12 exit
13 roadway edge

1.-10. (canceled)

11. A method for predicting a driving path of a motor vehicle, wherein during the operation of the motor vehicle, the method comprises:
ascertaining a respective environmental scenario currently situated ahead of the motor vehicle in a direction of travel;
ascertaining, for the respective ascertained environmental scenario, degrees of trustworthiness of several different data sources and/or data items originating from said data sources and on the basis of which the driving path is predictable; and
amalgamating together several of the data items originating from the various data sources in a weighted manner in accordance with the ascertained degrees of trustworthiness; and
using the amalgamated data to predict the driving path.

12. The method according to claim 11, wherein
the data and/or data sources comprise predetermined map data, a road model for estimating a road contour situated ahead, an estimated road contour situated ahead, a detection of a roadway-edge, cluster data specifying earlier vehicle movements, live trajectories of other road-users moving within the respective environmental scenario at the respective instant, a maneuver hypothesis of an assistance system of the motor vehicle, steering data pertaining to the motor vehicle, a yaw-rate of the motor vehicle and/or a driving-path prediction of a device for machine learning.

13. The method according to claim 11, wherein
the degrees of trustworthiness are inferred at least partially from a predetermined map in which a location-specific degree of trustworthiness has been specified for at least one data source and/or data type.

14. The method according to claim 11, wherein
environmental data that characterize the respective environmental scenario are recorded via environmental sensorics of the motor vehicle during the operation of the motor vehicle, and on the basis of said data the degrees of trustworthiness are ascertained dynamically, at least partially.

15. The method according to claim 11, wherein
a distance, as far as which, starting from a current position of the motor vehicle, at least one of the data sources and/or at least some of the data is/are to be used for predicting the driving path, is ascertained as a function of the environmental scenario ascertained in a given case.

16. The method according to claim 11, wherein
only those data sources and/or data, the degree of trustworthiness of which corresponds to at least a predetermined minimum degree of trustworthiness, are incorporated into the amalgamation and into the prediction of the driving path.

17. The method according to claim 11, wherein
for at least some of the data, uncertainty thereof is ascertained in addition, and said data are also weighted in accordance with said uncertainties, so that a greater uncertainty results in a lower weighting.

18. The method according to claim 11, wherein
objects in the respective environment of the motor vehicle that are relevant for guidance of the motor vehicle are selected based on the predicted driving path.

19. An assistance system for a motor vehicle, comprising:
an interface for capturing various data usable for predicting a driving path;
a processor and a computer-readable data memory coupled with the interface, wherein the assistance system is configured to:
ascertain a respective environmental scenario currently situated ahead of the motor vehicle in a direction of travel;
ascertain, for the respective ascertained environmental scenario, degrees of trustworthiness of several different data sources and/or data items originating from said data sources and on the basis of which the driving path is predictable; and
amalgamating together several of the data items originating from the various data sources in a weighted manner in accordance with the ascertained degrees of trustworthiness; and use the amalgamated data to predict the driving path.

20. A motor vehicle, comprising:
environmental sensorics for recording environmental data that characterize an environmental scenario situated ahead; and
an assistance system according to claim 19.
